(19) United States
(12) Patent Application Publication
(10) Pub. No.: US 2002/0086645 A1
(43) Pub. Date: Jul. 4, 2002

(54) Electronic apparatus comprising a display device which forms a control button

(76) Inventor: Arnaud Flegeo, Challes (FR)

Correspondence Address: Corporate Patent Counsel, U.S. Philips Corporation, 580 White Plains Road, Tarrytown, NY, 10591, US

(21) Appl. No.: 10/028,408

(22) Filed: Dec. 21, 2001

(30) Foreign Application Priority Data
Dec. 26, 2000 (FR) 0017047

(51) Int. Cl. H04B 1/38

(52) U.S. Cl. 455/90; 455/575; 455/425

(57) ABSTRACT

The invention proposes an electronic apparatus (10) which comprises a housing (12) of which one wall has a window (50) passed through by a display device (52) such as a liquid crystal display device (52), and of the type of which the housing (12) accommodates at least a first electric switch (74) which permits the modification of the electric state of an associated control circuit, such as a control circuit for the display device (52), characterized in that said display device (52) comprises at least an external control part (66) to which a user can apply a control force, and an internal activation part (68) of which an activation surface (70) can co-operate with a trigger element (72) of the associated electric switch (74), and in that the display device (52) is arranged movable relative to the housing (12) between a rest position and an activation position in which the activation part (68) cooperates with the trigger element (72) of the switch (74).

The invention relates to an electronic apparatus which comprises a display device.

The invention more particularly relates to an electronic apparatus which comprises a housing of which one wall comprises a window that is passed through by a display device.

In a general way the display device passes through the front face or main face of the electronic apparatus.

The electronic apparatus also comprises switches which are activated by keys or push buttons and which permit to modify the electric state of a control circuit, notably of the control circuit of the display device. The keys thus form a keypad which generally also passes through the main face of the electronic apparatus or partly a side face.

The modification of the electric state of a control circuit permits to control a function of the electronic apparatus.

The display device gives alphanumeric information which may vary much, such as digits or letters for a telephone or an “organizer”. The display device may also show pictograms, drawings or images when the device is, for example, an electronic game.

In order to satisfy the needs and desires of consumers, the electronic apparatus have more and more functions in ever smaller volumes.

In consequence, the electronic apparatus are to comprise a sufficient number of control devices to permit the control of all the functions of the apparatus. The increase of the number of functions thus causes an increase of cost and/or cumbersomeness of the control devices.

By way of example the display devices of the mobile telephones frequently comprise characters which may be digits and/or letters, spread over several display rows and columns. It is thus necessary to be able to rapidly and easily move a cursor in the screen so as to be able to move the cursor to each of the characters.

The moving of the cursor is also called “navigation” of the cursor in the display device.

Electronic games also call for the moving of a cursor on the display device.

These moves are obtained via specific control devices which may be formed by one or more keys which co-operate with associated electric switches and which modify the control circuit of the display device for controlling the movement of the cursor.

It is known to associate a key with each way of movement in one of the directions on the display device.

The key may be an additional key, which leads to an increase of the dimensions of the keypad and, in consequence, of the electronic apparatus, which is the opposite to miniaturization.

Another solution proposes to use an already existing key which permits to control a first function, such a key being called dual function key. However, it is necessary to provide that another key is activated for switching between the two functions controlled by the dual function key. This makes it necessary always to know what the function is that will be realized when the dual function key is pressed. This solution diminishes the simplicity of use of the electronic device.

The specific control device may also comprise a navigation wheel. The movement of the cursor is then proportional to the rotation of the wheel.

When the electronic apparatus is a mobile telephone, for example of the GSM type, the wheel is advantageously arranged in a side wall of the telephone so as to facilitate its use. However, the navigation wheels require a specific sensor which permits to supply information that represents the rotation of the wheel to the control circuit of the display device. Moreover, it is necessary to provide an additional opening in the housing, so that the wheel is accessible from the exterior.

The specific sensor as well as the realization of the additional opening increase the cost of manufacture of the electronic apparatus concerned. In addition, the use of a wheel generally permits the movement of the cursor only in one direction in either way.

The specific control device may also comprise a pointing element also called track ball.

Such a pointing element comprises a lever or a ball. The cursor is moved over the screen as a function of the movement or rotation and the way and direction of the movement or rotation applied to the lever or the ball, respectively.

Similarly to the use of a wheel, the pointing element requires a specific costly sensor.

In order to provide an electronic apparatus that can realize a maximum of functions which can be controlled by the user in a simple and rapid manner at less cost and having minimum cumbersomeness, the invention proposes an electronic apparatus which comprises a housing of which one wall has a window passed through by a display device such as a liquid crystal display device, and of the type of which the housing accommodates at least a first electric switch which permits to modify the electric state of an associated control circuit, such as a control circuit of the display device, characterized in that the display device comprises at least an external control part to which the user can apply a control force and an internal activation part of which an activation surface co-operates with a trigger element of the associated electric switch, and in that the display device is mounted movably relative to the housing between a rest position and an activation position in which the activation part cooperates with the trigger element of the switch.

According to other characteristic features of the invention:

the rest position of the display device relative to the housing is determined, towards the exterior of the housing, by a mechanical stop;

an electronic apparatus comprises elastic means which permanently return the display device to its rest position;

the elastic means belong to the switch;

the electronic apparatus comprises at least a movable key for activating a second associated switch;

the first and the second switch are carried by a common support element;

the common support element extends substantially in one plane, the activation part of the display device as well as the key are each mounted movably in a direction which is substantially perpendicular to said plane;

the display device comprises four peripheral control parts which are spread over the display device in four different directions relative to a central area of the device, and of which each one may co-operate with a trigger element of an associated electric switch;

the external control parts are located and realized so that the user easily and intuitively spots them;

the electronic apparatus comprises sealing means situated at the space between the window and the display device to avoid pollution such as dust penetrating the housing;

the sealing means are formed by a soft film which is fixed to the faces of a wall of the display device and the wall of the housing on either one side of the space between the window and the display device.

These and other aspects of the invention are apparent from and will be elucidated, by way of non-limitative example, with reference to the embodiment(s) described hereinafter.

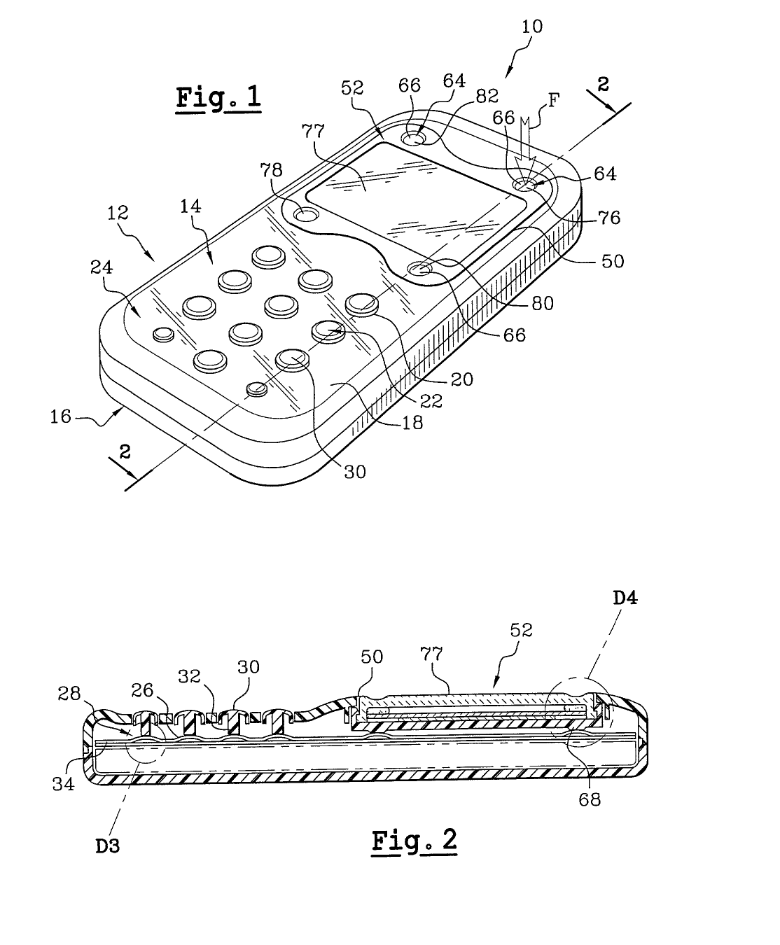

FIG. 1 is a perspective view of an electronic apparatus realized according to the invention;

FIG. 2 is a longitudinal sectional view of the electronic apparatus along line 2-2 represented in FIG. 1;

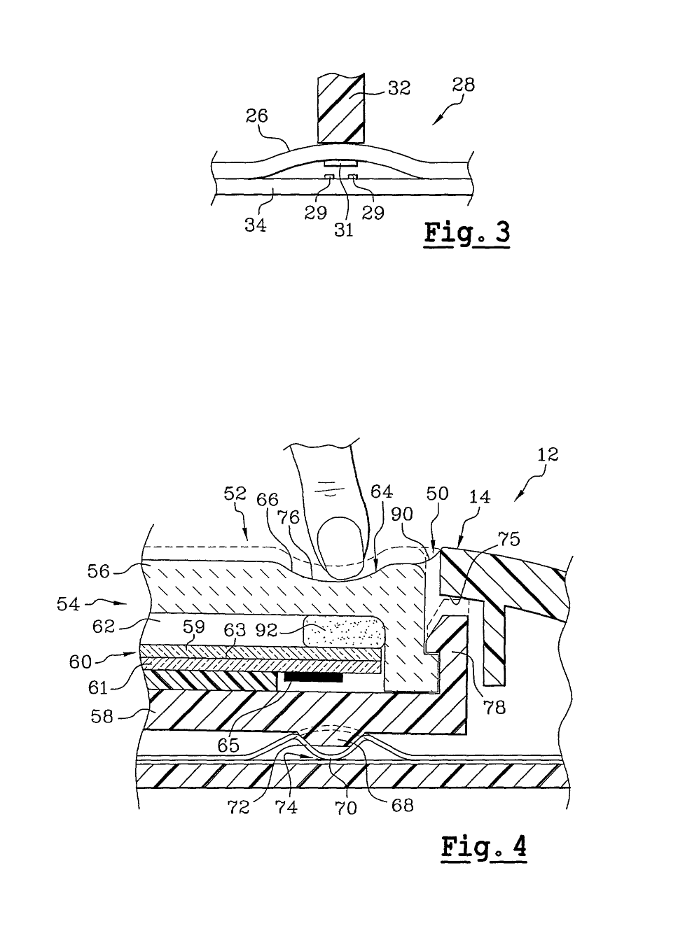

FIG. 3 is a large-scale view of the detail D3 represented in FIG. 2;

FIG. 4 is a large-scale view of the detail D4 represented in FIG. 2.

In the following of the description an upper or lower orientation will be used in conformity with the orientation from top to bottom of the Figures.

FIG. 1 represents an electronic apparatus 10 which is here by way of example a mobile telephone of the GSM type.

The telephone 10 comprises a housing 12 formed by an upper half 14 and a lower half 16.

The upper surface 18 of the upper half 14 has openings 20 which permit to pass through the keys 22 of a keypad 24 of the telephone 10. The keys 22 can move vertically between a rest position and an activation position in which each co-operates with an activation element 26 of an associated electric switch 28 (FIG. 2).

The keypad 24 is here formed by twelve keys 22 which are spread over four horizontal series of three keys each.

The keys 22 are mainly formed by an upper control part 30 to which a finger of a user can apply a control force. The part 30 forms the back of the corresponding key.

As represented in FIG. 2, the keys 22 are also formed by a lower rigid activation part 32 which may co-operate with the trigger element 26 of the associated electric switch 28. The lower rigid activation part 32 is realized in the form of a central pin which vertically protrudes from the lower surface of the back of the upper part 30 of the corresponding key 22 as far as the upper wall of the trigger element 26 of the associated electric switch 28 which is, for example, an elastically deformable dome.

Each electric switch 28 is mainly formed by two metallic tracks 29 represented in detail in FIG. 3, belonging to an associated electric control circuit and which are not electrically interconnected when the associated key 22 is in a position of rest.

When the key 22 is in an activating position, the lower part 32 deforms the dome 26, so that an electrically conducting part 31 of its lower surface comes into contact with the two metallic tracks, thus modifying the electric state of the associated electric control circuit so as to control a function of the electronic apparatus 10.

The function may comprise, for example, taking the telephone line, dialing a figure of the number to be dialed, moving a cursor in a display device 52 or validating a previously realized operation.

In general, the upper parts 30 and lower parts 32 are realized in one piece by injection molding a rigid material such as plastic.

The metallic tracks of the switches 28 are fixed, for example, via metallization to a common support element 34 which extends in a substantially horizontal plane and which may be a plastic film. The tracks belong, for example, to the upper surface of a printed circuit board.

The upper half 14 of the housing 12 of the electronic apparatus 10 also has a window 50 which is passed through by a display device 52 such as a liquid crystal display device which is here substantially rectangular.

According to the invention the display device 52 is mounted movably relative to the housing 12 between a rest position represented in FIG. 2 as well as in FIG. 4 in a broken line and an activation position represented in a solid line in FIG. 4.

The display device 52 mainly comprises a chamber 54 which is formed by an upper part 56 of transparent material such as plastic which is fixed on a lower support part 58 via elastic fitting.

A display screen 60 is arranged in a cavity 62 which is defined by the upper part 56 and lower part 58 of the chamber 54.

The screen 60 is mainly formed by two glass plates 59 and 61 between which is a fine layer 63 of liquid crystal.

The liquid crystal layer 63 is electrically connected via electrodes 65 to a control device which is connected to electric control circuits associated to electric switches.

The operation of the screen 60 of known type will not be described in more detail.

According to the invention the display device 52 comprises four peripheral control parts 64 which are substantially spread to the four comers of the display device 52 so as to be spread in the display device 52 in four different directions relative to a central area 77 of the device 52.

The four peripheral control parts 64 are referred to as 76, 78, 80 and 82 of FIG. 1.

Each peripheral comer part 64 comprises an external control part 66 to which the user may apply a control force, simplified by the arrow F represented in FIG. 1, and an internal activation part 68 (FIG. 4) of which a lower activation surface 70 co-operates with a trigger element 72 of an associated electric switch 74 for controlling, for example, one function of the electronic apparatus 10.

The external control parts 66 are to be located and realized so that the user easily and intuitively spots them.

The external control parts 66 here have a form of a bowl to follow closer the form of the finger tip of the user.

According to variants of embodiment the external control parts 66 may comprise a boss, a colored area or an area on which a design or a script is realized.

Each external control part 66 may also be a combination of these solutions, that is to say, for example have a form of a bowl on which a relief design is realized whose color may be different from that of the external part and which advantageously represents the function realized when a control force is applied.

The simplified reference of the parts 66 may thus result from a touch-sensitive and visual combination.

The trigger elements 72 and the electric switches 74 associated to the peripheral parts 64 are advantageously identical or similar to the trigger elements 26 and to the switches 28 of the keys 22 of the keypad 24.

The invention also proposes that the metallic tracks of the switches 74 belong to the common support element 34. Thus, all the switches 28 and 74 of the electronic apparatus are gathered on the common support element 34 which facilitates their manipulation and their positioning and their assembling in the housing 10.

Moreover, the extra cost resulting from the realization of the four switches 74 on the common support element 34 is very little.

The internal activation parts 68 which are similar to the lower parts 32 consist of bosses which are realized on the lower surface of the lower part 58 of the chamber 54.

According to FIG. 4 the rest position of the display device 52 relative to the housing 12 is determined, towards the exterior of the housing 10, by a mechanical stop 75 formed by the upper half 14.

As a matter of fact, the dimensions of the lower part 58 are larger than the dimensions of the window 50. Thus the free edges 78 of the display device 52 are blocked by the stop 75 formed by the periphery of the window 50.

The electronic apparatus 10 comprises elastic means which permanently bring back the display device 52 to its rest position. These elastic means are here formed by the trigger elements 72 of the switches 74 associated to the peripheral parts 64.

Thus when the user applies a control force, for example, to a first 76 external part 64, the display device 52 has a tipping movement relative to the free edges which are opposed thereto along an axis passing through the third 80 and fourth 82 external parts 64 neighboring the first external part 76.

The internal activation part 68 of the first external part 76 is vertically moved and deforms the trigger element 74 of the associated switch 74, contrary to its own elasticity, until it modifies the state of the control circuit.

The internal activation elements 68 of the third 82 and fourth 84 external parts 64 also move vertically. However, this move is insufficient for the trigger elements 72 of the associated switches 64 to modify the state of the control circuit.

It is also possible to apply a force to another part of the display device 52. Depending on the location of the point at which the force is applied, various trigger elements 72 can co-operate concomitantly with the associated switches 74.

In this case the concomitant change of state of the associated electric control circuits can control one or various functions of those which are controlled during the non-concomitant change of state of these same electric control circuits.

The spreading of the external control parts 66 to the four corners of the display device 52 is particularly well adapted for controlling the navigation of the cursor. Indeed, pressing on each of the external control parts 66 permits the cursor to move in one way of a direction. This way of the direction advantageously corresponds to the position of the corresponding external control part 66 relative to the center 77 of the display device 52.

Thus, the navigation of the cursor becomes intuitive as the cursor moves in a direction of the external control part 66 on which the user exerts a force.

According to a variant the display device 52 may comprise a fifth internal activation part which is advantageously located at the center 77 of the lower support part 58. The associated switch can thus permit to modify the electric state of a circuit which permits the validation of a preceding operation such as the keying-in of a telephone number.

The electronic apparatus 10 according to the invention thus permits in a simple, economic and trouble-free way to control additional functions relative to an equivalent apparatus which has a keyboard and a conventional display device, that is to say, a fixed display device relative to the housing.

In accordance with FIG. 4 the electronic apparatus 10 comprises a soft film 90 which forms sealing means which permits to avoid pollution such as dust penetrating into the housing 12.

The soft film 90 is fixed, for example, by sealing or heat-sealing on the outside surface of the upper half 14 of the housing 12 near the edges of the window 50, and covers the upper wall of the upper part 56 of the chamber 54. The softness of the film 90 permits to be deformed so that it can thus follow the movements of the chamber 54 relative to the housing 12.

A sealing cord 92, which may be an expanded substance such as foam rubber, is arranged between the upper part 56 of the chamber 54 and the liquid crystal display screen 60 to partially isolate the screen 60 from vibrations transmitted by the part 56, and to avoid dust or dirt penetrating between the screen 60 and the upper part 56 of the chamber 54.

1. An electronic apparatus (10) comprising a housing (12) of which one wall comprises a window (50) passed through by a display device (52) such as a liquid crystal display device (52) and of the type whose housing (12) accommodates at least a first electric switch (74) which permits to modify the electric state of an associated control circuit such as a control circuit of the display device (52), characterized in that the display device (52) comprises at least an external control part (66) to which a user can apply a control force, and an internal activation part (68) of which an activation surface (70) may co-operate with a trigger element (72) of the associated electric switch (74), and in that the display device (52) is mounted movable relative to the housing (12) between a rest position and an activation position in which the activation part (68) co-operates with the trigger element (72) of the switch (74).

2. An electronic apparatus (10) as claimed in claim 1, characterized in that the rest position of the display device (52) relative to the housing (12) is determined, towards the exterior of the housing (12), by a mechanical stop (75).

3. An electronic apparatus (10) as claimed in one of the claims 1 or 2, characterized in that it comprises elastic means which permanently bring back the display device (52) to its position of rest.

4. An electronic apparatus (10) as claimed in claim 3, characterized in that the elastic means belong to the first switch (74).

5. An electronic apparatus (10) as claimed in any one of the preceding claims, characterized in that it comprises at least one movable key (22) for activating a second associated switch (28).

6. An electronic apparatus (10) as claimed in claim 5, characterized in that the first and second switches (74, 28) are carried by a common support element (34).

7. An electronic apparatus (10) as claimed in claim 6, characterized in that the common support element (34) stretches out substantially in one plane and in that the activation part (66) of the display device (52) as well as the key (22) are each mounted movable in one direction substantially perpendicular to said plane.

8. An electronic apparatus (10) as claimed in any one of the preceding claims, characterized in that the display device (52) comprises four peripheral activation parts (66) which are spread in the display device (52) in four different directions relative to a central area of the device (52) and of which each one may co-operate with a trigger element (72) of an associated electric switch (74).

9. An electronic apparatus (10) as claimed in any one of the preceding claims, characterized in that the external control parts (66) are located and realized for a user to spot them easily.

10. An electronic apparatus (10) as claimed in any one of the preceding claims, characterized in that it comprises sealing means situated at the space between the window (50) and the display device (52) so as to avoid pollution such as dust penetrating the housing (12).

11. An electronic apparatus (10) as claimed in any one of the preceding claims, characterized in that the sealing means are a soft film (90) which is fixed on the faces of a wall of the display device (52) and a wall of the housing (12) on either side of the space between the window (50) and the display device (52).
